(19) United States
(12) Patent Application Publication
(10) Pub. No.: US 2014/0174583 A1
(43) Pub. Date: Jun. 26, 2014

(54) Linepipe with cermet internal liner

(71) Applicant: Yongli Yang, Songyuan (CN)

(72) Inventor: Yongli Yang, Songyuan (CN)

(21) Appl. No.: 14/141,071

(22) Filed: Dec. 26, 2013

(30) Foreign Application Priority Data
Dec. 26, 2012 (CN) 201210573393.6

(51) Int. Cl. F16L 9/14

(52) U.S. Cl. CPC F16L 9/14
USPC 138/146

(57) ABSTRACT

A linepipe with cermet internal liner includes: a base pipe; a cermet layer comprising corundum and titanium; and an alloy layer comprising chromium, nickel and iron; wherein the cermet layer and the alloy layer are respectively provided on an internal wall of the base pipe from inside out along a radial direction thereof. From inside out, the cermet layer includes: anα-Al₂O₃ ceramic layer, a transition layer combined by two phases ofα-Al₂O₃ and metallic titanium, and a metallic titanium layer, wherein thicknesses of the three layers respectively account for ¼, ½ and ¼ thereof the cermet layer. A simple method for preparing the linepipe includes: mixing powders of Fe₂O₃, Al, TiO₂, Cr₂O₃ and NiO and sending into a base pipe, and sending the base pipe into a ultra-long centrifuge, so as to produce a linepipe of over 10 meters.

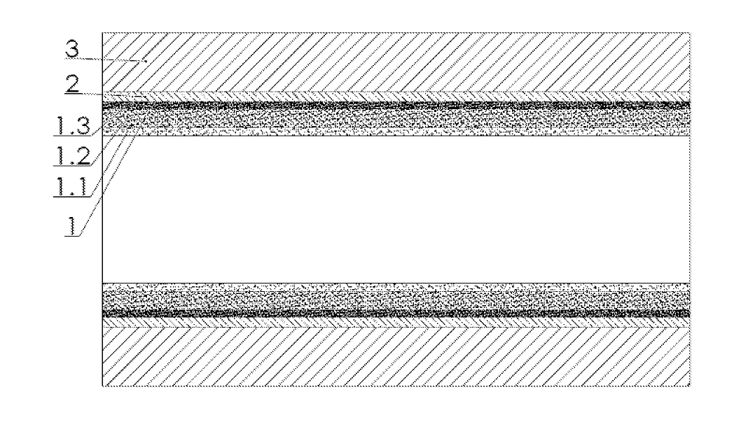

### CROSS REFERENCE OF RELATED APPLICATION

The present application claims priority under 35 U.S.C. 119(a-d) to CN 201210573393.6, filed Dec. 26, 2012.

### BACKGROUND OF THE PRESENT INVENTION

1. Field of Invention

The present invention relates to a new material in the fields of oil-gas gathering and transferring and water injecting, and more particularly to a pipeline a lined cermet which has characteristics of anticorrosion, scaling prevention, wear resistance, heat resistance, ultra long service life, is capable of being weld without damaging an internal anticorrosion layer on a weld joint thereof, and has no maintenance workload.

2. Description of Related Arts

The mediums for oil-gas gathering and transferring or water injecting contain plenty of corrosive substances and scaling substances, so the pipeline becomes corrosion perforation or scale blockage after working for a certain time, which has an effect ranges from impacting production up to causing security incidents. The phenomenon is not rare in international and domestic of China. Therefore, anticorrosion and scaling prevention treatments, internal anticorrosion in particular, are highly regarded.

Currently, the following measures are taken for internal anticorrosion of the oil-gas gathering and transferring pipes:

(1) selectively applying appropriate metal materials according to different mediums and application conditions, such as alloy steel and 13Cr, wherein however the metal material has drawbacks of high price, high investment, easy scaling and a slightly better effect than carbon steel;

(2) selectively applying nonmetal materials such as glass fiber reinforced plastics and organic anti-corrosive coating, wherein, however the nonmetal material has drawbacks of easy scaling, poor maintainability and non resistant abrasion, and the coating thereof may bulge or delaminate;

(3) media processing, which comprises removing harmful components of the media and lowering PH, so as to reduce corrosion of the media, wherein however the media processing increases operating costs and workload;

(4) adding chemicals, such as corrosion inhibitor, fungicide and scale inhibitor, which, however, increases operating costs and workload as well.

Therefore, providing a high comprehensive performance internal anticorrosion pipe has significantly economic returns and social benefits in oil-gas gathering and transferring. The linepipe with cermet internal liner is an optimal choice.

Cermet is a ceramic material with an incremental content of metal in the structure thereof. Cermet not only has toughness like steel, but also has characteristics of high hardness, corrosion resistance, heat resistance like ceramic. The cermet is a composite which not only has high strength, high hardness and high antioxidant capacity, but also has some ductility and high thermal stability.

Compared with material of the same class, in the cermet, a cermet layer is directly generated without removing metal oxide on a surface thereof. On the contrary, by taking right advantage of low surface energy, steady chemical properties and high hardness of α-Al₂O₃ ceramic layer, the cermet is utilized in pipelines for oil gathering and transferring, and water injecting, so as to achieve properties of non-corrosive, non-corrosion, welding without damaging an internal anticorrosion layer on a weld joint thereof and etc. Furthermore, due to ductility of metallic titanium, defects such as pinholes and micro-cracks of the single ceramic layer are overcome, which further highlights applicability thereof.

### SUMMARY OF THE PRESENT INVENTION

An object of the present invention is to provide a linepipe with cermet internal liner which has characteristics of anticorrosion, scaling prevention, without maintenance workload, heat resistance and capable of being weld without damaging an internal anticorrosion layer on a weld joint thereof. The linepipe with cermet internal liner of the present invention not only has chemical stability of ceramic such as non-corrosive, wherein a corrosion resistance thereof is dozens of times of stainless steel and hundreds of times of common steel material, but also has toughness of metal. A ceramic layer provided on an internal wall thereof has a low surface energy, non-polarity, not scaling (with a scaling rate of zero), without increasing resistance for fluid transportation. Therefore, the linepipe with cermet internal liner is the best internal anticorrosion pipe for oil-gas gathering and transferring and water injecting in oil and gas fields.

Accordingly, in order to achieve the objects mentioned above, the present invention is implemented by the following technical solution.

The composite linepipe with cermet internal liner is produced by a self-propagation high-temperature synthesis-centrifugal method. In a high dynamic balance and ultra-long centrifuge, alloy, which comprises titanium, chromium and nickel, is reacted with thermite, wherein a reaction thereof is an exothermic reaction. Under a centrifugation of 150 g (g is acceleration of gravity), molten products gradually are gradually separated due to different specific gravity thereof, in such a manner that an interpenetrative and gradually varied layered structure is formed. With heat dissipation of steel pipe, temperature thereof gradually decreases and each layer crystallizes and solidifies one after another. An innermost layer thereof is a cermet layer (1) which comprises corundum (α-Al₂O₃) (1.1) and metallic titanium, wherein due to different density thereof, content of α-Al₂O₃ decreases gradually and content of metallic titanium increases gradually, wherein thickness of surface layer, which is mainly composed of α-Al₂O₃, approximately accounts for ¼ thereof thickness of the cermet layer. The content of metallic titanium increases gradually and the content of α-Al₂O₃ decreases gradually along the radial, in such a manner that a two-phase transition layer (1.2) is formed, which accounts for ½ of the thickness of the cermet layer. Then continually down along the radial, the next is a metallic titanium layer, which further comprises a small amount of chromium, nickel and iron and approximately accounts for ¼ of the thickness of the cermet layer. Continually down along the radial, the next is an alloy layer (2) mainly comprising nickel, chromium, iron and a small amount of metallic titanium. Under high temperature, the alloy layer is fused together with an inner wall of a base pipe, so as to form a metallurgical bonding, wherein a melting layer of the metallurgical bonding is mainly composed of iron-nickel alloy.

Internal liner of the present invention has special properties due to special structures thereof, so as to form a new type anticorrosion, scaling prevention, paraffin control, wear resistance, heat resistance and high mechanical property material: linepipe with cermet internal liner which has excellent properties of anticorrosion, scaling prevention, wear resistance maintenance free and capable of being weld without damaging an internal anticorrosion layer on a weld joint thereof.

A pipe diameter of the product of the linepipe with cermet internal liner of the present invention is 38˜800 mm, and a length thereof is 6,000˜12,000 mm. A straightness of the linepipe with cermet internal liner is 0.2% meeting standard of American petroleum institute (API). The internal liner of the linepipe with cermet internal liner is 3˜5 mm. The linepipe with cermet internal liner has no pinholes and cracks appeared in the conventional ceramic-lined composite pipes, and quality thereof is at international advanced level.

The linepipe with cermet internal liner of the present invention is primarily put into practical application from laboratory around the world, and is a product of linepipe with cermet internal liner firstly reaches 12 m worldwidely.

Components of reactants and technological parameters thereof are as follows.

(1) The reactants are materials of 100˜200 mesh chemically pure powder. Preheated at 120° C., process thermal insulation for 2 hours, and mix according to proportions of chemical reaction; calculate total quantity of the reactants according to a proportion of 65% Fe, 25% Ti, 5% Cr and 5% Ni; wherein reaction equations are as follows:

2Al+Fe₂O₃═Al₂O₃+2Fe (1)

2Al+Cr₂O₃═Al₂O₃+2Cr (2)

4Al+3TiO₂═2Al₂O₃+3Ti (3)

2Al+3NiO═Al₂O₃+3Ni (4)

(2) The materials are put into a base pipe, and then the base pipe is put into an ultra-long centrifuge, wherein rotating speed of the centrifuge is determined as 150 g centrifugal force.

These and other objectives, features, and advantages of the present invention will become apparent from the following detailed description, the accompanying drawings, and the appended claims.

### BRIEF DESCRIPTION OF THE DRAWINGS

The FIGURE is a structural schematic diagram of a linepipe with cermet internal liner according to a preferred embodiment of the present invention.

Reference numbers of elements in the FIGURE: 1-cermet layer; 1.1-α-Al₂O₃ ceramic layer; 1.2-transition layer; 1.3-metallic titanium layer; 2-alloy layer; 3-base pipe.

Beneficial effects of the present invention are as follows.

(1) The linepipe with cermet internal liner adopts an internal anticorrosion layer made of cermet. The linepipe with cermet internal liner of the present invention has characteristics of anticorrosion which is hundreds of times of carbon steel and dozens of times of stainless steel, scaling prevention with a scaling rate of zero, excellent wear resistance which is 27 times of carbon steel, and all the characteristics mentioned above are all better than other internal anticorrosion method. The cermet layer and the pipe wall are metallurgical bonding which has mechanical properties of high bonding strength, high crushing strength and high impact resistance, without resistance increase after using for a long time and not requiring maintenance such as feeding balls or agent.

2. The internal liner is heat resistant and realizing truly welding without damaging an internal anticorrosion layer on a weld joint thereof, which improves anti-corrosive property of the welded junction, i.e., improves overall anticorrosion property of the pipeline.

### DETAILED DESCRIPTION OF THE PREFERRED EMBODIMENT

### Example 1

A linepipe with cermet internal liner has a size of φ89 mm*6 mm and a length thereof is 11.8 m. Reactants: 23.5 kg Fe₂O₃ powder, 17 kg Al powder, 5.9 kg TiO₂ powder, 1.17 kg Cr₂O₃ powder and 1.17 kg NiO powder. Rotating speed of a centrifuge is 1867 r/min. After reaction, a thickness of a cermet internal liner is 3.2 mm and a straightness thereof is 0.1%.

### Example 2

A linepipe with cermet internal liner has a size of φ114 mm*14 mm and a length thereof is 12 m. Reactants: 27.2 kg Fe₂O₃ powder, 20.3 kg Al powder, 6.8 kg TiO₂ powder, 1.35 kg Cr₂O₃ powder and 1.35 kg NiO powder. Rotating speed of a centrifuge is 1766 r/min. After reaction, a thickness of a cermet internal liner is 3.8 mm and a straightness thereof is 0.15%.

### Example 3

A linepipe with cermet internal liner has a size of φ159 mm*22 mm and a length thereof is 12 m. Reactants: 36.2 kg Fe₂O₃ powder, 26.7 kg Al powder, 9 kg TiO₂ powder, 1.8 kg Cr₂O₃ powder and 1.8 kg NiO powder. Rotating speed of a centrifuge is 1527 r/min. After reaction, a thickness of a cermet internal liner is 4.1 mm and a straightness thereof is 0.15%.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A linepipe with cermet internal liner for oil-gas gathering and transferring and water injecting, which is produced by a self-propagation high-temperature synthesis-centrifugal method, comprising: an internal anticorrosion layer which comprises a cermet layer comprising α-Al₂O₃ and titanium, and an alloy layer, wherein a length thereof is capable of reaching 6˜12 m, and a diameter thereof is capable of reaching 38˜800 mm, and a length thereof is below 0.2%.

2. The linepipe with cermet internal liner, as recited in claim 1, wherein additives matched with thermite and metal oxide in the producing process thereof are adjusted according to different requirement of products.

3. The linepipe with cermet internal liner, as recited in claim 1, as recited in claim 1, wherein when requirements of utilization thereof is not high, common linepipe with cermet internal liner is produced and utilized.

4. A linepipe with cermet internal liner, comprising:
a base pipe;
a cermet layer comprising corundum and titanium; and
an alloy layer comprising chromium, nickel and iron;
wherein the cermet layer and the alloy layer are respectively provided on an internal wall of the base pipe from inside out along a radial direction thereof.

5. The linepipe with cermet internal liner, as recited in claim 4, wherein the cermet layer comprises anα-Al₂O₃ ceramic layer, a transition layer combined by two phases of α-Al₂O₃ and metallic titanium, and a metallic titanium layer.

6. The linepipe with cermet internal liner, as recited in claim 5, wherein a thickness of the α-Al₂O₃ ceramic layer accounts for ¼ thereof the cermet layer, a thickness of the transition layer accounts for ½ thereof the cermet layer, and a thickness of the metallic titanium layer accounts for ¼ thereof the cermet layer.

7. The linepipe with cermet internal liner, as recited in claim 4, wherein from inside out along a radial direction of in the cermet layer, content of α-Al₂O₃ decreases gradually and content of metallic titanium increases gradually;
in transition layer, the content of metallic titanium increases gradually and the content of α-Al₂O₃ decreases gradually along the radial, in such a manner that a two-phase transition layer is formed;
in the metallic titanium layer further comprises a small amount of chromium, nickel and iron;
the alloy layer mainly comprises nickel, chromium, iron and a small amount of metallic titanium, under high temperature, the alloy layer is fused together with an inner wall of a base pipe, so as to form a metallurgical bonding, wherein a melting layer of the metallurgical bonding is mainly comprising iron-nickel alloy.

8. The linepipe with cermet internal liner, as recited in claim 1, wherein the linepipe with cermet internal liner is produced by the following method comprising steps of:
preheating reactants are powders of Fe, Ti, Cr and Ni which are 100˜200 mesh chemically pure powder at 120° C., process thermal insulation for 2 hours, and mixing according to proportions of chemical reaction; calculating total quantity of the reactants according to a proportion of 65% Fe, 25% Ti, 5% Cr and 5% Ni; wherein reaction equations are as follows:
2Al+Fe₂O₃═Al₂O₃+2Fe (1)
2Al+Cr₂O₃═Al₂O₃+2Cr (2)
4Al+3TiO₂═2Al₂O₃+3Ti (3)
2Al+3NiO═Al₂O₃+3Ni (4)
(2) putting the materials into a base pipe, and then putting the base pipe is into an ultra-long centrifuge, wherein rotating speed of the centrifuge is determined as 150 g centrifugal force.

9. The linepipe with cermet internal liner, as recited in claim 4, wherein the linepipe with cermet internal liner is produced by the following method comprising steps of:
preheating reactants are powders of Fe, Ti, Cr and Ni which are 100˜200 mesh chemically pure powder at 120° C., process thermal insulation for 2 hours, and mixing according to proportions of chemical reaction; calculating total quantity of the reactants according to a proportion of 65% Fe, 25% Ti, 5% Cr and 5% Ni; wherein reaction equations are as follows:
2Al+Fe₂O₃═Al₂O₃+2Fe (1)
2Al+Cr₂O₃═Al₂O₃+2Cr (2)
4Al+3TiO₂═2Al₂O₃+3Ti (3)
2Al+3NiO═Al₂O₃+3Ni (4)
(2) putting the materials into a base pipe, and then putting the base pipe is into an ultra-long centrifuge, wherein rotating speed of the centrifuge is determined as 150 g centrifugal force.
